(19) United States
(12) Patent Application Publication
(10) Pub. No.: US 2005/0213566 A1
(43) Pub. Date: Sep. 29, 2005

(54) System and method for network selection in a communication system using a shared RAN

(76) Inventors: Sami Jutila, Oulu (FI); Tony Hulkkonen, Helsinki (FI); Hannu Hietalahti, Kiviniemi (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/811,304

(22) Filed: Mar. 29, 2004

(51) Int. Cl. H04L 12/66

(52) U.S. Cl. 370/352; 370/400

(57) ABSTRACT

The invention provides a method, system, terminal, and access network for selecting a service or service provider in a shared network configuration which includes at least one terminal, at least one access network, and at least two alternatively selectable services or service providers accessible via the access network. The access network broadcasts, to the terminal, a shared network domain, SND, code which indicates that at least two services or service providers are accessible via the access network. The broadcast SND code is changed only when there is a change in available services or service providers accessible via the access network. The terminal checks, only when SND code changes, available services or service providers by accessing a memory storing a list of SND codes and associated services or service providers. The terminal or the access network or another network element selects a service or service provider available in the shared network.

### FIELD AND BACKGROUND OF THE INVENTION

The present invention relates to a method, system and network elements for network selection in a communication system using a shared RAN.

In PCT/EP00/04647, a system is disclosed which comprises a shared network, that is a network used by two or more different providers. Several problems can arise in such a structure providing a shared network having several service providers, where UE does not know the identity of the service providers. According to PCT/EP00/04647, information about service providers is broadcast over the radio via the broadcast channel. UE listens to this broadcast information, selects a service provider, and indicates the selected service provider (CN operator) to the RAN, so that RAN can route UE's registration request to the selected CN. A first problem related to such a structure is that the UE has to listen and decode this broadcast information in every cell which slows down cell reselection process, increases battery consumption, etc. A further problem is that there can be several operators also sharing the CN. In gateway core network architecture, the CN does not know which CN operator was selected. A next problem is that broadcast based solution may not be implemented because some companies do not want to make extensive changes to the broadcast channel.

As an alternative to the broadcasting of multiple PLMN Id's in a Shared RAN environment, other means exist for a mobile station to select PLMN in a shared network. Partly such a solution includes changes on how network names are displayed on the mobile terminal in relation to what is broadcast and stored on SIM/USIM. Such a solution is based in part on the Rel-5 Iu/A/Gb-flex standard, “Intra-domain connection of RAN nodes to multiple CN nodes”, and leverages the mechanisms to select one out of multiple CN nodes. Combined with introducing a limited IMSI analysis, where MCC/MNC is extracted and compared to the PLMN Id's behind the Shared RAN, such a solution should handle the major part of mobile stations registering to a Shared RAN PLMN network. The remaining part of the registrations can be handled as pre-rel-6 mobile stations.

According to this concept, the UE sends its own MCC/MNC to the RNC. If one of the core networks has same MCC/MNC, initial NAS message is routed to that network. Otherwise routing destination is selected “randomly”. This works as long as home network is part of the MOCN, but REL-6 UEs are treated in same way REL-5 UEs when the UE is roaming outside home network.

### SUMMARY OF THE INVENTION

According to a first aspect, the invention provides a method for selecting a service or service provider in a shared network configuration which includes at least one terminal, at least one access network, and at least two alternatively selectable services or service providers accessible via the access network, comprising the steps
the access network broadcasts, to the terminal, a shared network domain, SND, code which indicates that at least two services or service providers are accessible via the access network,
the broadcast SND code is changed only when there is a change in available services or service providers accessible via the access network,
the terminal checks whether SND code changes, and, when detecting that SND code has changed, checks whether it contains or has access to information regarding available services or service providers associated to the changed SND code, and
the terminal or the access network or another network element selects an available service or service provider.

The terminal preferably checks whether the SND code changes on a regular or irregular intermittent basis, or when the cell, the location area or routing area changes. When detecting that the SND code has changed from the previous code to a new code, the terminal checks whether the new SND code is already known to it. If yes, the terminal checks the services or service providers available in the present environment in which the new SND code is broadcast. The terminal may execute these checks by accessing a memory storing a list of SND codes and associated services or service providers. The terminal accesses the memory using the new SND code, and checks whether services or service providers are stored in the memory associated to the new SND code. The memory may preferably be an internal memory of the terminal such as a SIM or USIM. The memory may also be provided outside of the terminal.

When the new SND code received by the terminal is not known to the terminal, the terminal or the access network or another network element detects services or service providers available in the present environment preferably by receiving broadcast or dedicated downlink information which indicates the services or service providers available in the present environment, that is associated to the new SND code. Then, the terminal or the access network or another network element selects a service or service provider available in the present environment.

The SND code change can occur due to change of cell that broadcasts different SND or the serving cell changing its broadcast SND, due to e.g. network configuration change.

According to another aspect, the invention provides a system for selecting a service or service provider in a shared network configuration which includes at least one terminal, at least one access network, and at least two alternatively selectable services or service providers accessible via the access network, wherein
the access network is configured to broadcast, to the terminal, a shared network domain, SND, code which indicates that at least two services or service providers are accessible via the access network,
the access network is configured to change the broadcast SND code only when there is a change in available services or service providers accessible via the access network,
the terminal is configured to check whether the broadcast SND code changes, and, when detecting that the SND code has changed, checks whether it contains or has access to information regarding available services or service providers associated to the SND code, and
the terminal or the access network or another network element is configured to select an available service or service provider.

According to a further aspect, the invention provides a terminal for use in a system for selecting a service or service provider in a shared network configuration which includes the terminal, at least one access network, and at least two alternatively selectable services or service providers accessible via the access network, wherein
the terminal is configured to check whether an SND code broadcast by the access network changes, and when detecting that the SND code has changed, to check whether it contains or has access to information regarding available services or service providers associated to the changed SND code, and
the terminal is configured to select, when detecting that it contains or has access to information regarding available services or service providers associated to the changed SND code, an available service or service provider associated to the changed SND code.

The terminal may check available services or service providers by accessing a memory storing a list of SND codes and associated services or service providers if the changed SND is already known by the terminal, otherwise by receiving broadcast or dedicated downlink information.

According to another aspect, the invention provides an access network for use in a system for selecting a service or service provider in a shared network configuration which includes at least one terminal, the access network, and at least two alternatively selectable services or service providers accessible via the access network, wherein
the access network is configured to broadcast, to the terminal, a shared network domain, SND, code which indicates that at least two services or service providers are accessible via the access network, and
the access network is configured to change the broadcast SND code only when there is a change in available services or service providers accessible via the access network.

The access network is preferably configured to select an available service or service provider.

### BRIEF DESCRIPTION OF THE DRAWINGS

FIG. 1 shows a basic structure of an embodiment of the invention; and

FIG. 2 illustrates a basic structure of another embodiment of the invention; and

FIGS. 3 to 9 show flow charts and structures of further embodiments of the invention.

### DETAILED DESCRIPTION OF EMBODIMENTS OF THE INVENTION

The embodiments of the invention provide for shared RAN/CN network selection. It is a benefit for operators to share the Radio networks so that they can use common base-stations and other Radio resources and the users will be routed to right Core network based on subscriber. In case the subscriber does not have any preference then a core network can be selected based on an appropriate principle.

There is no easy downward-compatible way to indicate the core networks behind the shared network. By adding more broadcast information there is a risk that old terminals can not use the network at all. Also by excessive broadcast information the network selection procedures become easily slow and ineffective. By adding just an information element such as the SND code which tells whether the network supports the proposed mechanism the old terminals will work properly even when the mechanism is in use.

The invention provides an optimisation by Shared Network Domain areas. According to embodiments of the invention, a Shared Network Domain, SND, corresponds to an area for which a system information, e.g. SND identity or SND code, broadcast by the shared RAN is the same. This means that the same CN operators are available behind the shared RAN. The CN operators may preferably also have the same configuration i.e. Network Mode of Operation, NMO, for the same SND code. An SND is set of one to several location areas. The proposed SND solution, compared to an LA based mechanism, may work as follows: Each cell in a shared RAN, e.g. UTRAN, broadcasts the identity of the Shared Network Domain. This identity is called here SND identity or SND code. The SND identities may be unique within the shared RAN, or may be of a “color-code” fashion, i.e. not unique within the shared RAN. When UE detects that the broadcast SND identity or code has changed, it preferably checks the identities of available CN operators and their associated network configuration information, e.g. from its USIM, the ME memory or from the network, depending on whether the new SND code is known by the terminal or not, before registering to the network.

The procedure can be optimised such that the UE temporarily, or permanently, stores the information, that is the identities of available CN operators and their associated network configuration information of the new SND code for later use. When the UE next time enters the same SND area it identifies the shared network domain identity and retrieves the associated information from either USIM or terminal equipment.

An advantage of the proposed concept of using SND codes resides in the fact that the UE does not have to check the identities of available CN operators when LA or RA changes, in case the current SND the UE is moving under has not changed.

The proposed SND concept adds another area concept to existing RA, LA, and pool areas. Preferably, the UE stores the SND identity or code and compares it at each LA change. For this purpose, at LA change, the UE reads and compares the SND identity or code broadcast in the new LA with the stored SND identity or code of the old LA. When the SND codes are identical, no further action is taken. When the SND codes are different, the UE checks the new operators etc behind the new SND code.

According to one or more of the embodiments of the invention, information about the shared network may be stored into a memory (e.g. a USIM card or terminal memory) and may be utilized in network selection.

According to another embodiment, the user preference may be presented in registration request for shared RAN network either just prior to the registration request or embedded in registration request. This information is needed only if user has some preference for some core network or if the subscription has some preference for some core network or some of the core networks are forbidden for subscriber.

Additionally there may be a mechanism for querying the core network identities from shared RAN. This mechanism will make future network selections in the area of shared RAN more successful. Also some other user requested “super searches” for updating shared RAN lists or “querying the Core networks inside current RAN” can easily be implemented.

The invention makes it possible to transfer smoothly to more advanced core network selection so that terminals supporting invention will work also in networks that do not support core network selection in shared RAN and old terminals will work in new and old kind of shared networks.

The embodiments of the invention present solutions to problems in a shared network having several service providers, where UE does not know the identities of the available service providers. The solutions according to the invention can be used as alternatives or in arbitrary combinations.

According to a first solution, a concept called shared network domain, SND, is introduced. Information indicating the shared network domain, such as a code or identifier, is broadcast. The UE listens to the broadcast information indicating the shared network domain and decodes it only when shared network domain information changes. The change of the information in the broadcast channel indicates that the shared network domain has changed. Some of the benefits are significantly simplified cell reselection process and longer battery life for UE.

There can be several operators also sharing the core network, CN. In gateway core network architecture, the CN does not know which CN operator was selected. According to an implementation of the invention, the selected CN operator identity may be sent to the CN over the Iu interface. A benefit is that the providers, e.g. Virgin as a MVNO, can get their own subscribers in all networks in which they provide service. E.g. Virgin subscribers of Virgin network ‘X’ will select Virgin network ‘Y’ when they roam in that network.—Shared network operators using gateway core network appear as regular operators to roamers. Operators partnering in shared gateway core network can thus offer different tariffs.

When the broadcast based solution is not be selected, e.g. because a company does not want to make extensive changes to the broadcast channel, a query based solution can be used as a potential alternative. This solution also uses the shared network domain concept. I.e. the query is performed when the shared network domain code changes. A benefit is that changes to the broadcast channel, which is a scarce resource, especially in GSM, need not be made. It is likely that broadcast based solution is not selected at least for GSM A/Gb mode.

The specific shared code changes to a new one when CN circumstances changes. This provides a technically effective, simple and patentable solution.

According to embodiments of the invention, a specific shared code will be broadcast in area of shared RAN, and the code will change to a new one whenever circumstances in CN situation will change. The invention provides a simple, technically effective method for shared RAN situations.

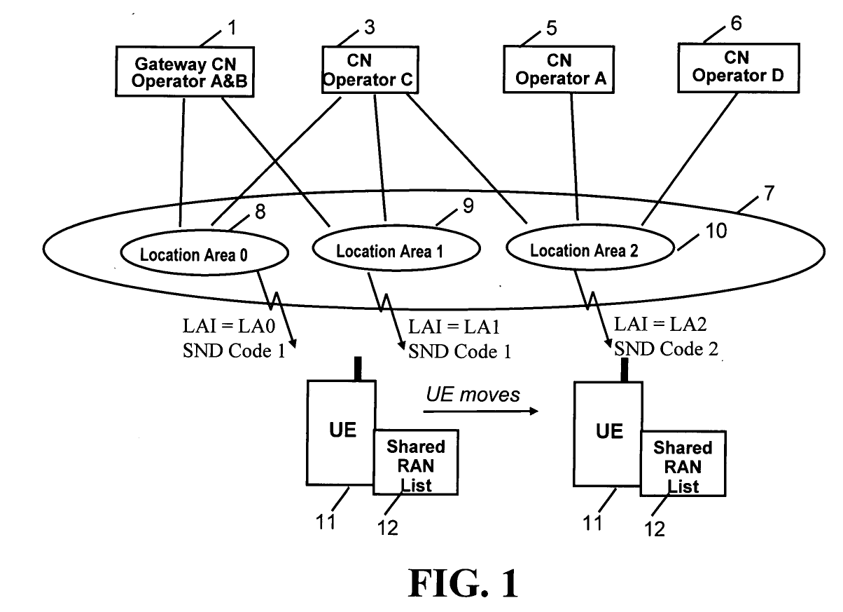

FIG. 1 shows a basic structure of an embodiment of the invention. According to FIG. 1, a Gateway Core Network, CN, Operator A&B 1, a CN Operator C 3, a CN Operator A 5, and a CN Operator D 6 are provided which provide services, operation, or infrastructure, to a network 7. The network 7 provides or includes a plurality of location areas, LA, such as “Location Area 0” 8, “Location Area 1” 9, and “Location Area 2” 10. In each location area, a location area identifier, LAI, is broadcast identifying the location area. For Location Area 0 a LAI “LA0” is broadcast which includes a Shared Network Domain, SND, code1. The SND code1 indicates or represents the operators 1, 3 as available, that is selectable, in Location Area 0. In Location Area 1 a LAI “LA1” is broadcast which includes the same Shared Network Domain, SND, code1. The SND code broadcast for the Location Areas 0 and 1 is identical as the same operators 1, 3 are serving or operating these LAs 8, 9.

For Location Area 2, a LAI “LA2” is broadcast which includes a Shared Network Domain, SND, code2. The SND code2 broadcast for the Location Area 2 is different from the SND Code1 as the list of operators available in LA 2, that is operators 3, 5, 6, is different from the operators list available for LAs 0, 1.

A mobile terminal such as User Equipment, UE, 11 is attached or attachable to the network 7. FIG. 1 shows a case where the UE 11 is moving from Location Area 0 to Location Area 1 and then further to Location Area 2, and thus successively receives the SND codes and then the SND code 2.

The UE 11 is equipped with a storage 12 in which a Shared RAN list is stored which indicates the operators assigned to the different SND codes1, 2 etc. When receiving a new SND code, e.g because of movement to another location area or because of broadcasting of a changed SND code, the UE 11 checks its storage 12, based on the received SND code, for finding the operators listed for the received SND code, that is operators available in the actual Location Area. Only when the SND Code changes, the UE 11 decodes the extended BCCH information.

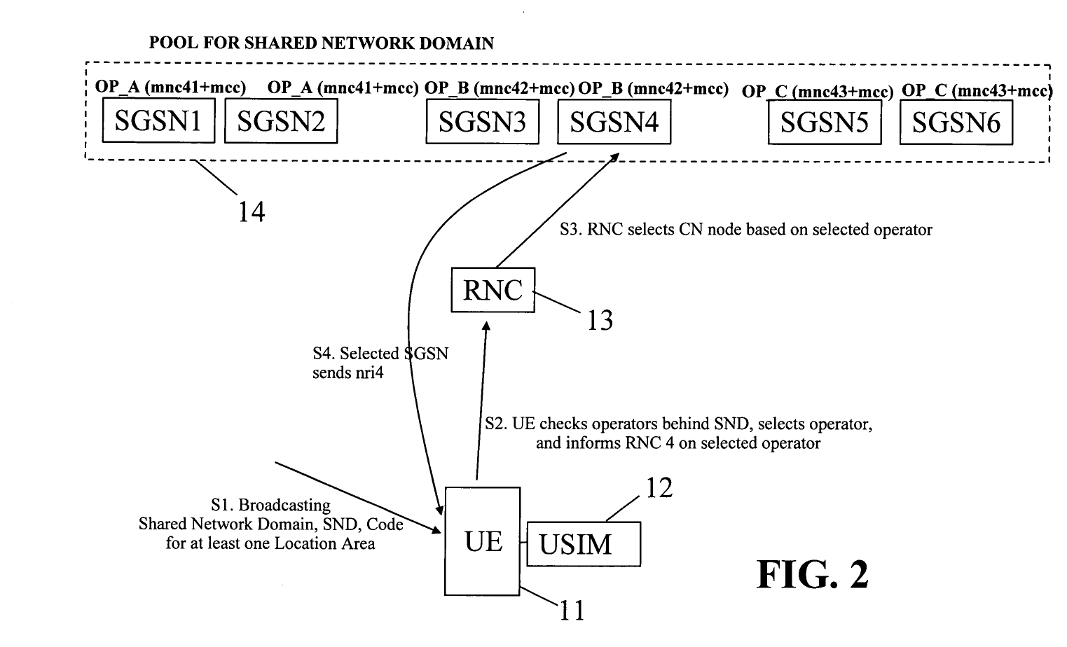

FIGS. 1 and 2 show the basic structure of embodiments of a system in accordance with the invention. The system includes one or more networks, or forms a part thereof. The network can connect to the at least one, or usually a plurality of, user equipments (UE) 11 which represent connection originating or terminating equipments and, in these embodiments, are implemented as mobile stations. The user equipments may also be of any other type of equipments such as stationary terminals. Although only one user equipment 11 is shown, usually several user equipments are attached to the network 7.

In case of connection, or connection set-up, with another equipment connectable via the network 7 or another network, a radio connection to the user equipment 11 is provided and handled by a radio access network (RAN). The RAN comprises, in these embodiments, a radio network controller (RNC) 13 which is part of, or represents, the radio access network for radio connection to user equipment 11. Usually, several radio access networks and controllers 13 may be provided in the networks for radio coverage of the different areas of the networks. The RNC 13 may be selectively connected to different serving entities, e.g. nodes which, in the embodiment of FIG. 2, are implemented as SGSNs (Serving GPRS Support Nodes) SGSN1 to SGSN6.

The network may comprise additional or alternative serving nodes such as mobile switching centres (MSCs) which normally will be combined with visitor location registers (VLRs). The serving nodes SGSN1 to SGSN6 may be connected, if necessary, to a gateway node which can be implemented as GGSN (Gateway GPRS Support Node) and provides the possibility of connection to other networks.

The invention additionally provides, according to a further aspect, one or more network elements equipped so as to implement the hardware structure or functions usable in a network or connection or selection method as defined in the claims and/or described in the present specification.

The present invention provides a solution for allowing a UE to decide on an operator to be used. As a possibility, a radio access network element such as a radio network controller or base station controller can decide which support node (e.g. SGSN) of the selected operator is to be used for attachment or connection (e.g. signalling connection and/or user traffic connection).

FIG. 2 shows an embodiment for implementing RAN sharing using SND by multiple networks operated e.g. by CN operators OP_A, OP_B, OP_C.

The CN operators OP_A, OP_B, OP_C comprise at least one support node, e.g. SGSN or MSC, connected to the RAN, e.g. to RNC 3. In the illustrated embodiments, two support nodes SGSN1, SGSN2, SGSN3, SGSN4, SGSN5, SGSN6, of each CN operator OP_A, OP_B, OP_C are shown to provide a pool 14 for SND.

Each CN operator OP_A, OP_B, OP_C may have its own identifier “mnc41”, “mnc42”, “mnc43” (mnc, mobile network code), as shown in the drawings. Further, each CN operators OP_A, OP_B, OP_C comprises, in this embodiment, two support nodes SGSN1, SGSN2; SGSN3, SGSN4; SGSN5, SGSN6, but may of course include only one or more than two support entities.

According to FIG. 2, the network(s) are broadcasting SND codes or identifiers. Thus, the SND information is broadcast and received by the UEs 11 (step S1).

Step S2: UE 11 checks, at least after a change of the broadcast SND code, operators behind the SND code e.g. by checking its USIM 12, selects, e.g. in accordance with internal selection criteria such as the criteria mentioned above, an operator and informs RNC 13 on the selected operator.

Step S3: RNC 13 may derives the operator code, e.g. mnc42, corresponding to the selected operator, and may select a CN node.

RNC 13 may be designed to freely select any available support entity of the selected operator network OP_B, for supporting the UE 11. In such a case, e.g. SGSN3 or SGSN4 can be selected. In this example SGSN 4 is chosen.

Step S4: The selected support entity SGSN4 sends its identifier nri4 to the UE 11 for confirming its availability for serving the UE 11.

According to FIGS. 1, 2, the USIM 12 stores a Shared RAN List. The shared RAN list in USIM 12 is used for storing the PLMN identities behind an SND code or shared RAN PLMN code. This list is updated either a) by operator by using SIM toolkit, e.g. when it or its partner participates in some new shared RAN schema, or b) by mobile station upon receiving a shared RAN code, SND code, for which is does not yet know the actual PLMN codes.

This concept allows to extend the shared RAN for multiple PLMN codes.

As an example, a SND code, that is a Shared RAN PLMN code, 244 37 may indicate that the Shared RAN allows access to the operators “244 05”=Radiolinja, and “244 91” Sonera.

In network selection and when displaying the names of networks for the user instead of showing the SND code 244 37 and name “shared RAN” the phone works as if networks Radiolinja and Sonera were heard.

In accordance with a further feature of embodiments of the invention, the broadcast information preferably includes an information element, IE, for indicating that the RAN is a shared RAN. The IE may consist of a bit such as a “shared RAN bit”. This IE indicates to the UE that the extended list, indicating the available operators, is valid only if the network broadcasts the information that it is a shared network. If the network does not broadcast this IE, shared network information, then the shared network code is not expanded. This mechanism is of advantage in order to keep compatibility for network elements that do not support CN selection behind a shared RAN.

When a network broadcasts this IE, that is the shared RAN info, or the SND code, it is adapted to support a mechanism where the UE 11 can select a desired network in the registration request. This feature allows CN Selection behind a shared RAN.

A new non-mandatory information element, IE, is preferably added to all registration requests where the UE can add a PLMN identity of selected PLMN, (IE: “to:”). In case the selected PLMN is not part of a shared RAN the registration response may include the list of PLMN identities behind the shared RAN.

Another non-mandatory information element may be added to all registration requests where the UE 11 can add the PLMN identities of forbidden PLMNs (that are used in shared RAN), (IE: “not_to:”). As an alternative way, these messages may be sent prior to a registration request, providing the benefit of no changes in existing messages. These messages are new routing messages which are optional.

According to an optional aspect, the invention may provide a mechanism to query the PLMNs behind the SND code, that is the shared RAN code. A message may be provided which can be sent from the UE 11 to the shared RAN (which broadcasts shared RAN information) to query the PLMNs behind the shared RAN. This query may be sent if the PLMN codes are not stored for shared RAN that is selected based on some network selection criteria. For instance the shared RAN network is selected at random as there are no other non-forbidden networks heard.

The query can also be initiated by the user if he wants to know about the network codes of manually selectable shared network. However, if user selects a shared network manually, and the PLMN codes for that shared RAN are not yet stored in USIM, there is no need to query the PLMN codes of shared RAN and CN selection behind the shared RAN may happen more or less at random. It is also possible to always indicate the shared networks in registration response from CN behind shared RAN but that might cause some overhead.

When a CN selection should fail when the UE is trying to register to a network that is not part of shared RAN, The RAN may send a list of the PLMN codes behind the shared RAN.

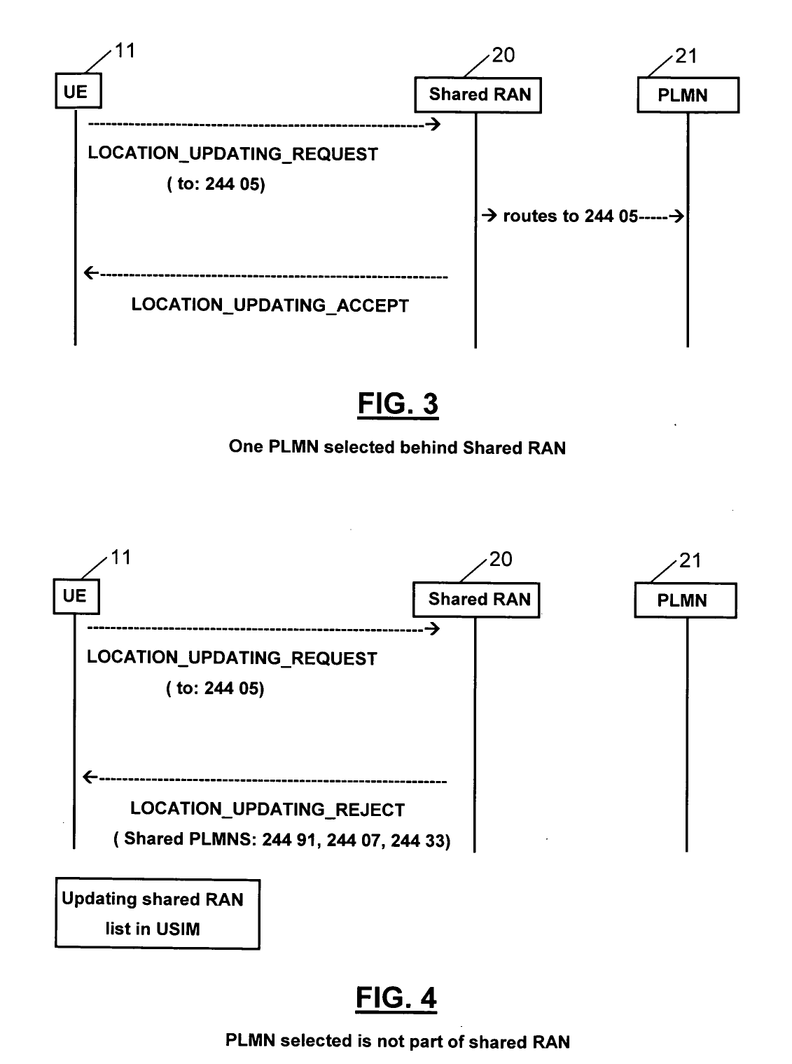

FIGS. 3 to 9 show some embodiments of selection of a network or operator 21 behind a Shared RAN 20. Note that the messages or message parts “to:” and “not_to:” can be sent from the UE 11 to the Shared RAN 20 before registration.

FIG. 3 shows a case where one PLMN is selected behind the Shared RAN 20. The UE 11 sends a message LOCATION_UPDATING_REQUEST (to: 244 05) to the RAN 20, indicating a desired operator or PLMN 21 “244 05”. The RAN 20 routes the call or connection to 244 05, and returns a message LOCATION_UPDATING_ACCEPT to the UE 11, confirming the connection to the selected PLMN 21.

FIG. 4 shows a case where the UE 11 tries to select one PLMN behind the Shared RAN 20 which PLMN is not part of, that is not accessible via, the shared RAN 20. Similar to the case of FIG. 3, the UE 11 sends a message LOCATION_UPDATING_REQUEST (to: 244 05) to the RAN 20, indicating the desired operator or PLMN 21 “244 05”. However, in this case, the PLMN 244 05 is not part of the shared RAN 20. The RAN 20 returns, to the UE 11, a reject message LOCATION_UPDATING_REJECT which message preferably includes information on the networks or operators “(Shared PLMNS: 244 91, 244 07, 244 33)” accessible via the shared RAN 20. The UE 11 thereupon updates the shared RAN list in USIM 12 by storing, for the presently broadcast SND code, that is shared RAN code, the received information on PLMNs available behind the shared RAN.

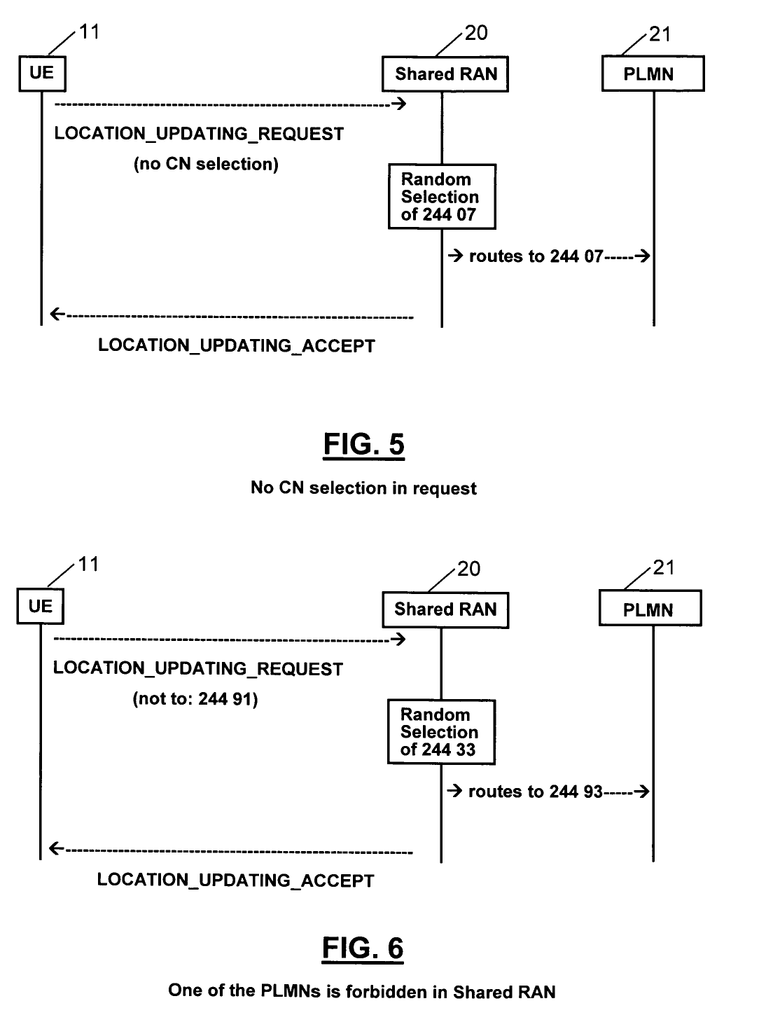

FIG. 5 represents a case where the UE 11 does not want to select any specific PLMN behind the Shared RAN 20. The UE 11 sends a message LOCATION_UPDATING_REQUEST (with no CN selection indication) to the RAN 20. The RAN 20 selects a core network on its own either at random or taking account of actual network load or usage etc. The RAN 20 routes the call or connection to the selected network 244 05, and returns a message LOCATION_UPDATING_ACCEPT to the UE 11, preferably indicating the connection to the selected PLMN 21.

FIG. 6 represents a case where the UE 11 does not want to be connected to a specific PLMN 244 91 behind the Shared RAN 20. The UE 11 sends a message LOCATION_UPDATING_REQUEST (with an information indicating the forbidden network, e.g. “not to: 244 91”) to the RAN 20. The RAN 20 selects a core network, other than the undesired network 244 91, on its own either at random or taking account of actual network load or usage etc. The RAN 20 routes the call or connection to the selected network 244 93, and returns a message LOCATION_UPDATING_ACCEPT to the UE 11, preferably indicating the connection to the selected PLMN 21.

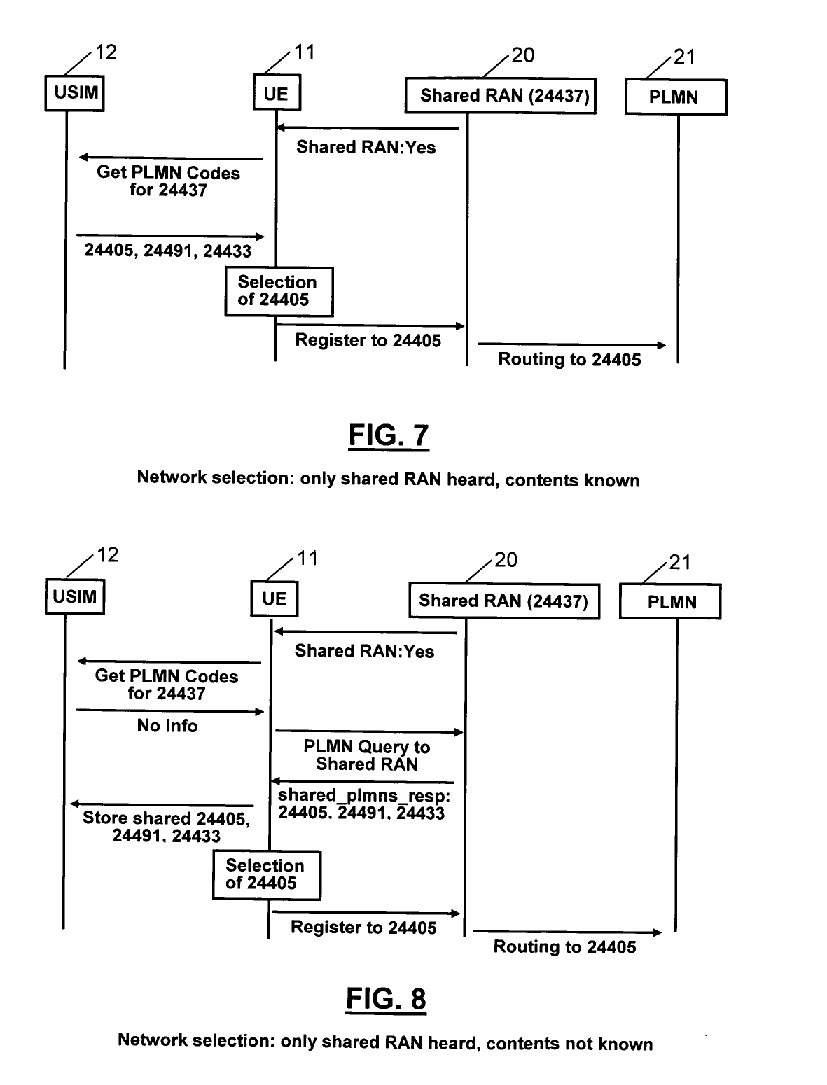

FIG. 7 shows a case of network selection wherein only shared RAN code, e.g. SND code, is heard, and the networks behind the shared RAN are known. The UE 11 selects a PLMN behind the Shared RAN 20. The RAN 20 broadcasts an SND code, e.g. 24437, and additionally may broadcast an information, e.g. a bit, that the RAN is a Shared RAN (“Shared RAN: YES”).

The UE 11 checks the memory 12, e.g. its USIM, in order to get the PLMN codes, e.g. 244 05, 244 91, 244 33, for the broadcast SND code 244 37. The UE 11 selects one of the network codes, e.g. 24405, and sends a message REGISTER (to: 244 05) to the RAN 20, indicating the desired operator or PLMN 21 “244 05”. The RAN 20 routes the call or connection to the selected network 24405.

FIG. 8 shows a case of network selection wherein only shared RAN code, e.g. SND code, is broadcast and heard by the UE but the networks behind the shared RAN are not known to the UE 11. The RAN 20 broadcasts an SND code, e.g. 24437, and additionally may broadcast an information, e.g. a bit, that the RAN is a Shared RAN (“Shared RAN: YES”).

The UE 11 checks the memory 12, e.g. its USIM, in order to get the PLMN codes for the broadcast SND code 24437. In the present case, the USIM 12 does not include a list of operators for this SND code 24437, and informs the UE 11 thereon, e.g. by returning a “no info” answer to the UE 11.

As a next step, the UE 11 sends a query, e.g. PLMN_query, to the RAN 20 which returns a list of operators available via the RAN 20, e.g. “shared_plmns_resp: 244 05, 244 91, 244 33”. The UE 11 instructs the USIM 12 to store the received list associated to the broadcast SND code (24437), “Store shared 244 37: 244 05, 244 91, 244 33”.

The UE 11 then selects one of the received network codes, e.g. 24405, and sends a message REGISTER (to: 244 05) to the RAN 20, indicating the desired operator or PLMN 21 “244 05”. The RAN 20 routes the call or connection to the selected network 24405.

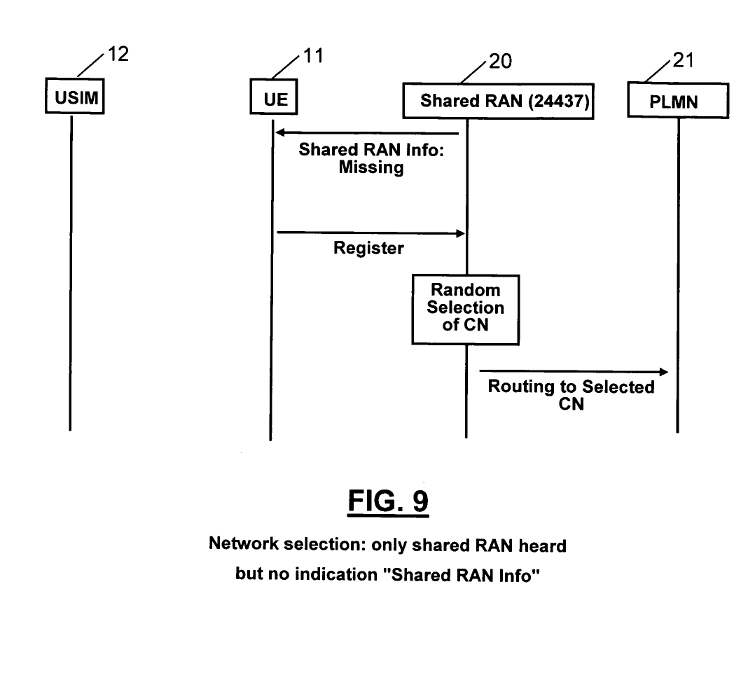

FIG. 9 illustrates an embodiment of network selection when only shared RAN code, e.g. SND code, is broadcast by the RAN 20, but no indication of “shared RAN info”.

The shared RAN 20 broadcasts its code, e.g. 24437, in which message a shared ran information is missing. When the UE 11 is of a type, e.g. an older type, which does not detect that the RAN is a Shared RAN, or which is not able to comply with automatic operator selection behind a Shared RAN, the call or connection will nevertheless be properly established. In this case, the UE 11 sends a Register message to the Shared RAN 20 without querying its memory, e.g. USIM 12. The Shared RAN (244 37) performs a selection, e.g. a more or less random selection of a CN behind the Shared RAN 20. The RAN 20 routes the call or connection to the selected network 21.

For users when searching networks, the names of found networks may be displayed. If shared RAN is indicated by at least one of its SND code or shared RAN information, the name or code of the shared RAN 20 need not be indicated at all, but only the names are displayed of the PLMNs that are stored in the memory of the UE 11, e.g. SIM or USIM, for the received shared RAN code, e.g. SND code.

If the shared RAN is not indicated, the name of the shared RAN may be shown.

The priority of shared network may be determined by the priorities of the PLMN codes stored for shared RAN if the information is stored (shared RAN +PLMN in USIM) and if the shared RAN indicates that it is shared (broadcast message).

The priority of the shared network may be determined by the priority of the shared PLMN code if the shared RAN does not indicate that it is shared, or the USIM does not store the PLMN codes for shared RAN.

There may also be a “super-search” initiated by a user where the terminal such as a phone would update all the shared RAN information to USIM. In this case, the user terminal may request the PLMN codes of all shared RANs that are heard and update them to USIM. If this is done then the CN selection will work in that area as all the PLMNs behind all the shared RANs are known. Also the operators may update the shared RAN lists over-the-air for instance by using SIM toolkit.

Possible way to store the shared RAN codes. A Datafield: shared RAN, and a Datafield id: 6F may be provided. When record length is for example 3*10 (+1)=Shared RAN code+9 PLMNs in RAN (+optionally a counter for when this has been used if complicated, replace algorithm).

Many other ways exist to store information. The USIM can also be replaced with a memory of other type such as a Mobile Equipment memory. The latter case reduces the possibility of the operator to prioritize the shared RANs (for instance by storing only the PLMNs it the user wishes to see the shared RAN list).

An algorithm to replace the records once the list gets full may be provided. This algorithm may be complicated or may just at random overwrite any existing record. If e.g. the storage space is good for, and fully occupied by, 50 records stored in the USIM and the 51st shared RAN code and list for this RAN needs to be stored then the ideal is to replace the oldest or least needed record. But without counters or other means it is difficult to know which record is least important. One way is just to replace any of the 50 records by picking at random a number between 1 and 50. Another alternative is to destroy one of the records which is not in country where the UE is actually now (based on MCC), or destroy one of the records which does not include any preferred or forbidden network.

When storing the PLMNs of shared RAN the order should be same as the priority of the PLMNs (note also the forbidden PLMNs) so that if there are more than for example 9 PLMNs sharing the same RAN the most important ones would be known.

The embodiments of the invention improve downward compatibility, and do not lead to overhead in broadcast messages which speeds up network selection.

According to embodiments of the invention, the PLMN names behind the shared RAN can be shown.

Some further features of embodiments of the invention include the feature of broadcasting a “shared RAN bit” indicating that the RAN is a shared RAN providing access to different operators. The extended list in the memory of the UE is valid and checked only if the network broadcasts information that it is a shared network. If the RAN does not broadcast shared network information then the shared network code is not evaluated. This mechanism is of advantage in order to keep compatibility for network elements that do not support CN selection behind a shared RAN.

An optional implementation of the invention may include the extension of the broadcast “Shared RAN” info to consist of more than one bit so as to indicate more than only the: on/off, use “share code” information.

If the “shared RAN bit” is extended to for instance 8 bits then it is possible to have 256 different core network combinations under one shared RAN PLMN combination.

This kind of extension makes the invention more versatile as under one RAN PLMN code it is easy to make different kind of core network combinations. Also the PLMN codes do not run out so easily.

For instance share code 1 can include core operators A,B and C. Share code 2 can include core operators A,D. Share code 3 can include core operators B,C,E,F; and so on; share code 255 can include core operators C, K.

The share code (Broadcast messages), that is the SND code, can be placed in the broadcast message at any appropriate place, As an example, one simple place is that some LAC (location area code) range is reserved for share codes. Location area codes are 16 bit long entities, which can be allocated freely by operator. It is possible to agree for instance that if LAC is in range 0xF000-0xF0FF then the share code can be read for LAC as follows

| LAC | SND code |
|---|---|
| 0xF000 | 0 |
| 0xF001 | 1 |
| 0xF002 | 2 |
| 0xF003 | 3 |
| 0xF004 | 4 |
| . | . |
| . | . |
| . | . |
| 0xF0FF | 255 |

This implementation is totally downward-compatible, at least if networks that do not support shared RAN do not broadcast those LAC codes (the “freshness of network” can be checked also by other means).

Another easy place is to define some Cell Identities range to indicate shared RAN.

The share code in LAC guarantees that terminals that do not support shared RAN extensions also make location updates when entering to new shared code area. That is necessary at least in those cases when the terminals was registered to a core network which is no longer available in new core network combination. So this also solves the routing issues for old terminals.

If the share code is coded in any other place then some old terminals might be registered to a core network that is not available under current RAN.

The share code range by using LAC can be made also smaller or bigger by adjusting the range size. (0xF000-0xF00F) would mean 16 codes. (0xF000-0xFFFF) would mean about 4096 codes. (not quite, as there are some reserved LAC values 0xFFFE).

It is also possible to define share code using some extension mechanisms in current broadcast messages so that the LAC codes can be used in their original meaning without stealing some bits of LAC.

There are many other ways to define the “shared code” in broadcast messages. Another example of coding is that if some special bit in broadcast message is “1” (or “0”) then shared RAN is in use. The shared RAN code can be then read from LAC so that the lower byte tells the shared code. This kind of solution might be most feasible so that the LAC values can be allocated more freely and the shared RAN does not run out of LAC codes. At the same time it can be ensured that also old terminals that do not understand shared RAN can make location updating every time when entering a new share code area.

These are just examples of possible coding systems (for instance the share code length may be 2,3,4,5,6,7,8, . . . bits). But for compatibility it is be advisable to use LAC to convey the share code (old terminals need to make location updating if core network configuration in shared RAN changes).

The shared RAN list in USIM 12 is used for storing the PLMN identities behind a shared RAN PLMN code. This list is updated either by operator by using SIM toolkit when it or its partner participates in some new shared RAN schema, or by a mobile station upon receiving a shared RAN code for which is does not (yet) know the actual PLMN codes.

At least if the “shared RAN code” idea is adopted the user terminal UE 11 may be configured to have two different shared RAN lists in the USIM.

The first list may be an Operator controlled RAN list which list holds the information about shared RANs that are most important for user subscription. This first list may be updated using SIM TOOLKIT update. The second list may be a Terminal controlled RAN list. This second list holds the information about shared RANs that are updated/deleted/replaced by mobile station when it finds shared RANs that operator has not considered most important. Typically in this list there are some shared RANs that are found when roaming outside of the home country, or, in home country, some shared RANs where the USIM has no subscription for any of core networks and the phone has lost network coverage. Also some local, small shared RANs can be inserted in this second list.

The reason for providing two lists is that it is hard to predict how often the terminal will update the list. Normally terminal controlled RAN list is updated only if there is no preferred networks heard in area and the terminal such as a phone is in automatic mode. But it might be that in some countries the shared RAN becomes very common and if the terminal is in such a country it might update the list quite often. Then when the shared list becomes full and new entry needs to be written it is hard/impossible to know which “shared RANs” are important and which are not and therefore the important shared RAN information might be deleted and thus when the terminal comes back to area of “Home shared RAN” it might not recognize it as easily as it could if it had not deleted information about the “Home shared RAN”. Also if “super search” is one option for user and there are plenty of shared RANs around then the lists become full quickly. “Supersearch” means a network search+query core networks from all shared RANs that are not yet known in USIM.

Whether two lists are provided depends then on whether user has some “important shared RANs” where there is either “home” or “partner” core network available. If there is no such shared RANs then terminal controlled RAN list is sufficient to give user visibility of core networks around.

With regard to the feature of broadcast a “shared RAN bit”, the extended list of available operators is valid or used only if the network broadcasts information that it is a shared network. If it does not broadcast shared network information then the shared network code is not expanded. This mechanism is provided in order to keep compatibility for network elements that do not support CN selection behind a shared RAN.

The broadcast Shared RAN info may be a) an information element telling whether shared RAN exists or not [SHARED RAN BIT]+b) an information element telling the shared code length [SHARED RAN LENGTH], or telling how many bits of LAC are used for “shared code” (to get maximum flexibility).

If the network indicates that it is shared, but 0 bits are used for shared code, e.g. the SND code, then the network uses same core networks everywhere where the shared RAN is indicated.

If the network indicates that it is shared and 1 bit of LAC is used for shared code then network has two different core network combinations: 2 bits=>4 combinations; 3 bits=>8 combinations, etc, and the maximum is 16 bits=>the whole LAC is used for “shared code”.

In USIM the value “FFFE” as shared code means, according to an embodiment, that whole RAN is using same CN combination (for networks that do not have many CN combinations). Note that “FFFE” has been defined as deleted LAC and should never be broadcast by any network. In USIM or other terminal memory there is stored “PLMN”+“SHARED CODE” [3+2 bytes]+the core networks under each of such combination when they become “important”.

Some additional features of embodiments of the invention include the following. If “steal LAC bits” for shared RAN code uses MSB bits of LAC, the operator name to be displayed can be changed easily by using already specified methods such as LAC range in USIM OPL data field.

An extension field, EF, such as EFOPL (Operator PLMN List) contains a prioritised list of Location Area Information (LAI) identities that are used to associate a specific operator name contained in an extension field EFPNN, PLMN Network Name Record Identifier, with the LAI. The terminal ME shall use this EF in association with the EFPNN in place of any network name stored within the ME's internal list and any network name received when registered to the PLMN. If the EFPNN is not present then this file shall not be present.

A “Query of CN networks” can also be implemented by using slow broadcast mechanisms such as short message cell broadcast in GSM.

Broadcast of CN networks can be made conditional, e.g. so that it is started in case there is at least one subscriber in base-station coverage area who is interested in knowing what CN networks there are inside shared RAN.

Although preferred embodiments have been described above, the invention is not limited thereto and may also be implemented using other types of messages or codes or different systems or networks.

1. Method for selecting a service or service provider in a shared network configuration which includes at least one terminal, at least one access network, and at least two alternatively selectable services or service providers accessible via the access network, comprising the steps
the access network broadcasts, to the terminal, a shared network domain, SND, code which indicates that at least two services or service providers are accessible via the access network,
the broadcast SND code is changed only when there is a change in available services or service providers accessible via the access network,
the terminal checks whether SND code changes, and, when detecting that SND code has changed, checks whether the terminal contains or has access to information regarding available services or service providers associated to the changed SND code, and
the terminal or the access network or another network element selects an available service or service provider.

2. Method according to claim 1, wherein
the terminal, when detecting that the SND code has changed from the previous code to a new code,
checks whether the new SND code is already known to it, and, if yes,
checks the services or service providers available in the present environment in which the new SND code is broadcast,
wherein the terminal executes these checks by accessing a memory storing a list of SND codes and associated services or service providers.

3. Method according to claim 1, wherein
when the terminal detects that the new SND code received by the terminal is not known to the terminal, the terminal or the access network or another network element detects services or service providers associated to the new SND code by receiving broadcast or dedicated downlink information which indicates the services or service providers associated to the new SND code.

4. Method according to claim 1, wherein the same SND code is broadcast for one or several location areas, LAs.

5. Method according to claim 1, wherein the terminal stores the SND code broadcast in the present access network or location area of the terminal in a memory, and, when changing from the present access network or location area to a new access network or location area, compares the stored SND code with the SND code broadcast in the new access network or new location area.

6. Method according to claim 1, wherein the service providers are operators.

7. Method according to claim 1, wherein the services are mobile services.

8. Method according to claim 1, wherein the access network broadcasts, in addition to the SND code, an information element indicating that the access network is a shared radio access network which provides access to at least two selectable services or service providers.

9. Method according to claim 8, wherein the terminal checks whether or not the access network broadcasts the information element, and, when detecting that the access network broadcasts the information element, accesses its memory for finding the available selectable services or service providers.

10. System for selecting a service or service provider in a shared network configuration which includes at least one terminal, at least one access network, and at least two alternatively selectable services or service providers accessible via the access network, wherein
the access network is configured to broadcast, to the terminal, a shared network domain, SND, code which indicates that at least two services or service providers are accessible via the access network,
the access network is configured to change the broadcast SND code only when there is a change in available services or service providers accessible via the access network,
the terminal is configured to check whether the broadcast SND code changes, and, when detecting that the SND code has changed, to check whether the terminal contains or has access to information regarding available services or service providers associated to the SND code, and
the terminal or the access network or another network element is configured to select an available service or service provider.

11. System according to claim 10, wherein the terminal includes a memory storing a list of SND codes and associated services or service providers.

12. System according to claim 10, wherein the access network is configured to broadcast the same SND code for one or several location areas, LAs.

13. System according to claim 12, wherein the terminal is configured to store the SND code broadcast in the present access network or location area of the terminal in a memory, and, when changing from the present access network or location area to a new access network or location area, to compare the stored SND code with the SND code broadcast in the new access network or new location area.

14. System according to claim 10, wherein the service providers are operators.

15. System according to claim 10, wherein the services are mobile services.

16. System according to claim 10, wherein the access network is configured to broadcast, in addition to the SND code, an information element indicating that the access network is a shared radio access network which provides access to at least two selectable services or service providers.

17. System according to claim 16, wherein the terminal is configured to check whether or not the access network broadcasts the information element, and, when detecting that the access network broadcasts the information element, to access its memory for finding the available selectable services or service providers.

18. Terminal for use in a system for selecting a service or service provider in a shared network configuration which includes the terminal, at least one access network, and at least two alternatively selectable services or service providers accessible via the access network, wherein
the terminal is configured to check whether an SND code broadcast by the access network changes, and when detecting that the SND code has changed, to check whether the terminal contains or has access to information regarding available services or service providers associated to the changed SND code, and
the terminal is configured to select, when detecting that it contains or has access to information regarding available services or service providers associated to the changed SND code, an available service or service provider associated to the changed SND code.

19. Terminal according to claim 18, including a memory storing a list of SND codes and associated services or service providers.

20. Terminal according to claim 18, wherein the terminal is configured to store the SND code broadcast in the present access network or location area of the terminal in a memory, and, when changing from the present access network or location area to a new access network or location area, to compare the stored SND code with the SND code broadcast in the new access network or new location area.

21. Terminal according to claim 18, wherein the terminal is configured to check whether or not the access network broadcasts an information element indicating that the access network is a shared radio access network which provides access to at least two selectable services or service providers, and, when detecting that the access network broadcasts the information element, to access its memory for finding the available selectable services or service providers.

22. Access network for use in a system for selecting a service or service provider in a shared network configuration which includes at least one terminal, the access network, and at least two alternatively selectable services or service providers accessible via the access network, wherein
the access network is configured to broadcast, to the terminal, a shared network domain, SND, code which indicates that at least two services or service providers are accessible via the access network, and
the access network is configured to change the broadcast SND code only when there is a change in available services or service providers accessible via the access network.

23. Access network according to claim 22, which is configured to select an available service or service provider.

24. Network according to claim 22, wherein the access network is configured to broadcast the same SND code for one or several location areas, LAs.

25. Network according to claim 22, wherein the access network is configured to broadcast, in addition to the SND code, an information element indicating that the access network is a shared radio access network which provides access to at least two selectable services or service providers.
